(19) United States
(12) Patent Application Publication
(10) Pub. No.: US 2008/0100142 A1
(43) Pub. Date: May 1, 2008

(54) Electric appliance with constant power supplied-bus

(75) Inventor: Ching-Ling Chou, Taipei Hsien (TW)

Correspondence Address: BIRCH STEWART KOLASCH & BIRCH, PO BOX 747, FALLS CHURCH, VA, 22040-0747, US

(73) Assignee: TOPOWER COMPUTER INDUSTRIAL CO., LTD.

(21) Appl. No.: 11/783,724

(22) Filed: Apr. 11, 2007

Related U.S. Application Data
(63) Continuation-in-part of application No. 11/586,641, filed on Oct. 26, 2006.

(51) Int. Cl. H02J 9/00

(52) U.S. Cl. 307/64

(57) ABSTRACT

An electric appliance with constant power supplied-bus includes a power supply and a motherboard. A power transformation system of the power supply defines a main power system, which is electrically connected to an external power source for converting thereof as the electric appliance is under operation, and a standby power system, which has a constant electrical connection with the external power source for converting thereof into DC power, wherein the DC power outputted by the standby power system is used to drive a power on/off unit, which is used for outputting electric appliance-operating/appliance-shutdown signals. A bus is installed on the surface of the electric appliance and has a power transmission terminal and a data transmission terminal simultaneously, wherein the data transmission terminal is electrically connected with a data transmission port of the motherboard, and the power transmission terminal is electrically connected to the standby power system.

This application is a continuation-in-part, and claims priority, of from U.S. patent application Ser. No. 11/586,641 filed on Oct. 26, 2006, entitled “Computer Host with Bus Interface”.

### FIELD OF THE INVENTION

The present invention is related to an electric appliance with constant power supplied-bus, and more particularly to an electric appliance which can supply DC power to the bus even during the shutdown period.

### BACKGROUND OF THE INVENTION

Current power supplies in many electric appliances can transform the AC power into DC power, and the power supply includes a main power system, which drives the electric appliance through the DC power, and a standby power system, which drives shutdown signal through the DC power, wherein the standby power can provide a standby power in weak current no matter the electric appliance is under operation or shutdown, and as compared to the main power system which is mainly used to drive the operation of the electric appliance, the standby power system utilizes the standby power to achieve a remote control and an automatic power on/off.

Take computer host as an example. For the ATX (Advanced Technology extended) standard of motherboard, one characteristic thereof is that, except the integrally formed design and the DC power (3.3 V, 5 V, 12 V . . . ) provided during operation, a standby power system is also provided for supplying a starting power to the computer host, no matter the computer is under operation or shutdown. Alternatively, other electric appliances, such as TV or media player, also equip with the standby power system for executing remote power/off or time power on/off.

Besides, the current electric appliance technology also can be used in many external electronic devices which are operated independently under the shutdown condition, for example, speaker, night light, playing music CD directly through the panel of CD-ROM drive etc., or a small LED mounted on the case for displaying information of temperature, humidity, time, or a bright and dazzling case with an illuminating efficiency. However, for being applied to the electric appliances more widely, the general provided standby power system always provides a power intensity larger than the practical demand and might cause an energy waste since people pay more and more attention to the environmental consciousness and request to implement a more effective utilization of the energy and also to develop a replacing energy source.

In the bus device developed from the computer field, UBS (Universal Serial Bus) and IEEE-1394 are characteristic of hot plug and plug & play, so that they can be widely applied to various electric appliances owing to the convenience. According thereto, a great quantity of external electronic devices, such as mouse, keyboard, control lever, or other data transmission devices, are derived therefrom. Except for data transmission, because the bus also provide small amount of DC power, many devices which do not process data transmission but only receive power transmission, are further developed, for example, illuminating device, heating device, small LCD and charger for electronic device. Moreover, since the power of bus is supplied by the main power system, after the computer host is shutdown, the power supply of the bus is also stopped, and thus, if there is the need to use the electronic device alone, it has to be connected to a power-on electric appliance with bus for acquiring power through the bus. However, the power supply of the bus has the problem that the main power system always inputs a power larger than the real demand which obviously causes energy waste.

Consequently, if the original USB (or IE-1394) can be improved to provide DC power no matter the computer host is under operation or shutdown through utilizing another kind of electrical architecture, then the external electronic device with matched USB or IEEE-1394 connecter can directly obtain the power even when the computer host is shutdown so as to provide convenience, and also, the energy can be saved.

### SUMMARY OF THE INVENTION

The object of the present invention is to provide an electric appliance with constant power supplied-bus, in which the electric appliance includes a computer host, a TV, a play station for TV or computer, or a media player, and in the present invention, the standby power system of the power supply can always provide power to the bus, no matter the electric appliance is under operation or shutdown.

For achieving the object described above, a preferred embodiment according to the present invention includes a power supply and a motherboard electrically connected to the power supply. The power supply has a main power system and a standby power system, wherein the DC power outputted by the standby power system is used to drive a power on/off unit, which is used for outputting an electric appliance-operating signal and an electric appliance-shutdown signal. The motherboard has a logic operation circuit and a data transmission port electrically connected to inner electronic device. Further, at least a bus, which can be an USB or IEEE-1394 bus, is installed on the electric appliance and has a power transmission terminal and a data transmission terminal simultaneously or only a power transmission terminal, wherein the data transmission terminal is electrically connected with the data transmission port of the motherboard, and the power transmission terminal is electrically connected to the standby power system, such that the bus can connect to the power supply directly through a power transmission line or indirectly through the motherboard. Thereby, the bus mounted on the electric appliance receives only the power from the standby power system, and thus, the bus can acquire DC power no matter the electric appliance is under any condition (especially as shutdown).

Therefore, the electric appliance with the constant power supplied-bus can solve the problem that the general electric appliance might cause an energy waste owing to the standby power system continuously supplying an excess current during the power off period, or if it intends to employ the bus alone as the power output source, the electric appliance has to be powered on, which obviously might waste more energy. Thus, the multiple-purpose bus can be the power output source no matter the electric appliance is under any condition, such that the input power of the electric appliance (especially the power supplied by standby power system) can be utilized adequately so as to improve the using efficiency.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a structural drawing showing a preferred embodiment according to the present invention;

FIG. 2 is a structural drawing showing another preferred embodiment according to the present invention;

FIG. 3 is a circuit block showing a preferred embodiment according to the present invention;

FIG. 4 is a structural drawing showing the indirect connection between a power transmission bus and a power supply according to the present invention;

FIG. 5 is a structural drawing showing the direct connection between a power transmission bus and a power supply according to the present invention;

FIG. 6 is a circuit block of the embodiment in FIG. 4 and FIG. 5;

FIG. 7 is a structural drawing showing the electric appliance with constant power supplied-bus to be applied in a TV according to the present invention;

FIG. 8 is a structural drawing showing the electric appliance with constant power supplied-bus to be applied in a play station for TV or computer according to the present invention; and

FIG. 9 is a structural drawing showing the electric appliance with constant power supplied-bus to be applied in a media player according to the present invention.

### DESCRIPTION OF THE PREFERRED EMBODIMENT

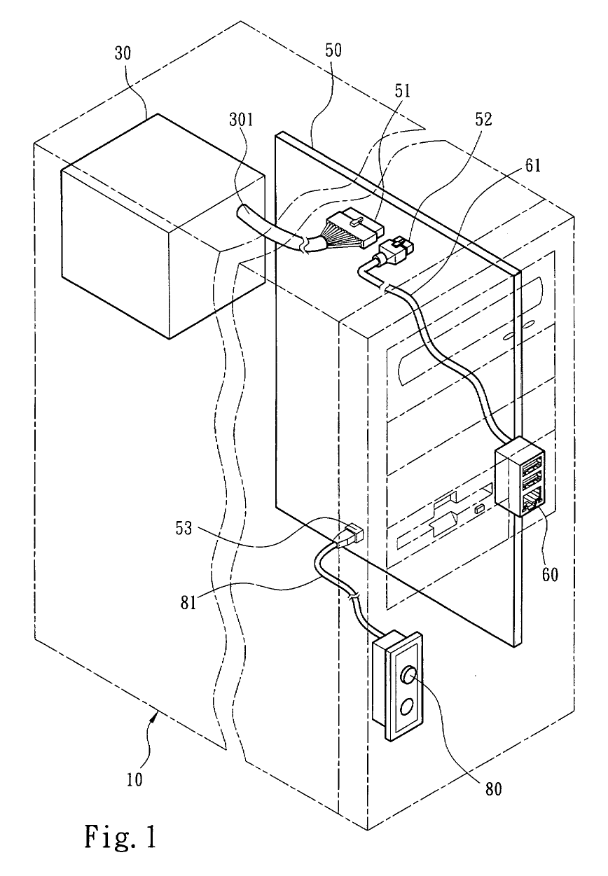

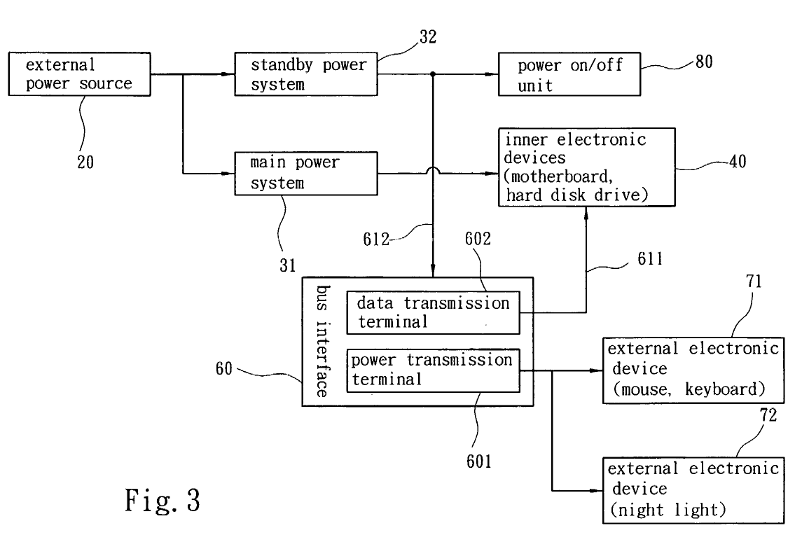

Refer to FIGS. 1 and 3, which are respectively a structural drawing and a circuit block showing an electric appliance with constant power supplied-bus in a preferred embodiment according to the present invention. As shown, in this embodiment, the electric appliance is a computer host 10, wherein the computer host 10 includes:

a power supply 30 having a main power system 31 electrically connected to an external power source 20 (which can be mains electricity) for converting thereof into DC power, and a standby power system 32 parallel connected with the main power system 31 for converting the external power source into DC power, wherein the DC power outputted by the main power system 31 is used to drive at least one inner electronic device 40 (such as motherboard, hard disk drive, CD-ROM drive . . . , etc.) and the DC power outputted by the standby power system 32 is used to drive a power on/off unit 80, which is used for outputting a computer operating signal and a computer shutdown signal, thereby controlling the operating or shutdown of the computer, so that, under operation, the main power system 31 has a DC power output, and during shutdown, the main power system 31 interrupts power supply (but the standby power system 32 remains to supply power under the AXT standard);

a motherboard 50 electrically connected to the main power system 31 and the standby power system 32, wherein the electrical connection between the motherboard 50 and the power supply 30 is provided by a power line 301 from the power supply 30 plugging into a socket 51 on the motherboard 50 so as to transmit power signal (including 5Vstb), and the motherboard 50 has a logic operation circuit and data transmission ports (which are also called I/O ports, and only a data/power transmission port 52 (including a data transmission port 52a and a power transmission port 52b) connected to the bus 60 is depicted in the drawings) for electrically connecting to other inner electronic devices 40, so that the inner electronic devices 40, such as hard disk drive, CD-ROM drive, may transmit data signal to the motherboard 50 through the data transmission port 52a for being processed by the logic operation circuit, and wherein the motherboard 50 further includes a starting-power transmission port 53 which may equip the DC power outputted by the standby power system 32 through the circuits on the motherboard 50, and a power transmission line 81 of the power on/off unit 80 is namely plugged into the starting-power transmission port 53 so as to electrically connect to the standby power system 32; and

a bus 60 (which is not limited to be USB (Universal Serial Bus) or IEEE 1394 bus) installed on the surface of computer host 10 and having terminals divided into a power transmission terminal 601 and a data transmission terminal 602, wherein multiple buses 60 can be integrated into an interface base, the data transmission terminal 602 is electrically connected with the motherboard 50 or other inner electronic devices 40 for data transmission, and the power transmission terminal 601 is electrically connected to the standby power system 32 for drawing the DC power so that the bus interface 60 can receive the DC power outputted from the standby power system 32, no matter the computer host 10 is under operation or shutdown.

In this preferred embodiment, the bus interface 60 is connected to the motherboard 50 by a power/signal transmission line 61 (which is an integration of a power transmission line 612 and a signal transmission 611 as shown in FIG. 3) and is electrically connected to the standby power system 32 through the data/power transmission port 52 (which also provides a power output) of the motherboard 50, so that when the computer host 10 is under operation, an external electronic device 71 (which needs power and data transmission both), such as mouse, keyboard, can be plugged thereinto, and when the computer host 10 is shutdown, since the bus interface 60 also can receive the power from the standby power system 32, other external electronic devices 72, such as night light, mobile phone charger, also can be plugged thereinto for drawing a power output.

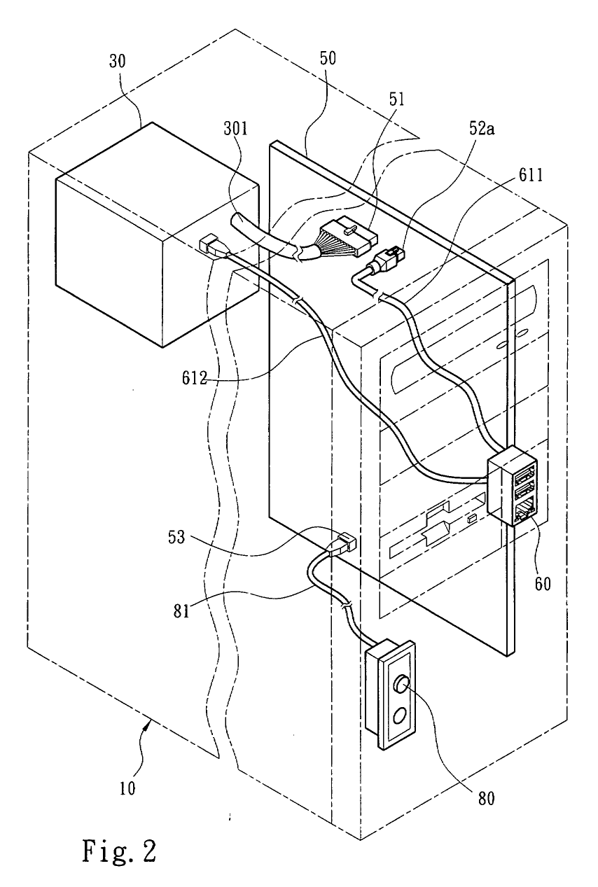

Refer to FIG. 2 which is another embodiment according to the present invention, wherein the bus interface 60 is equipped with a signal transmission line 611, which is connected with the data transmission port 52a of the motherboard 50 for data signal transmission, and also equipped with a power transmission line 612, which is connected to the power supply 30 for electrically connecting to the standby power system 32. Therefore, the efficiency identical to the embodiment described above can be achieved. In the aforesaid, the present invention provides a computer host 10 whose standby power system 32 in the power supply 30 may supply power to the bus interface 60 no matter under operation or shutdown, thereby external electronic devices 71, 72 having a corresponding connector (such as USB, IEEE 1394) can utilize the bus interface 60 to obtain the DC power from the standby power system 32 as the computer host is under operation or shutdown. Consequently, the power utilization can be improved.

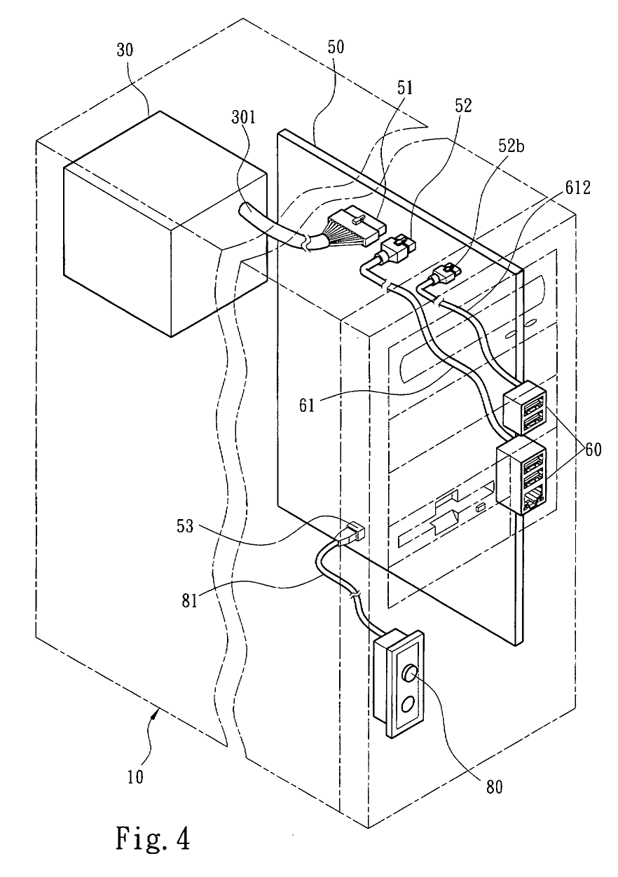

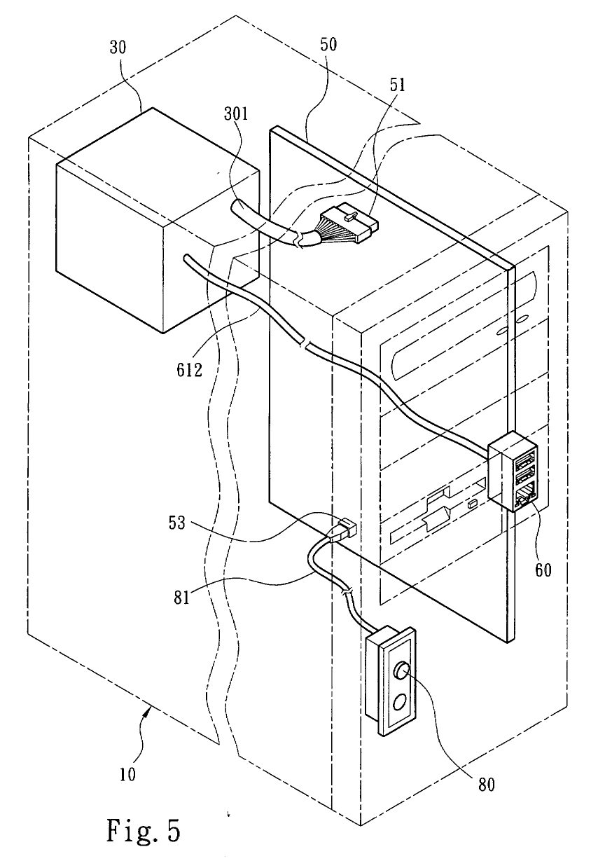

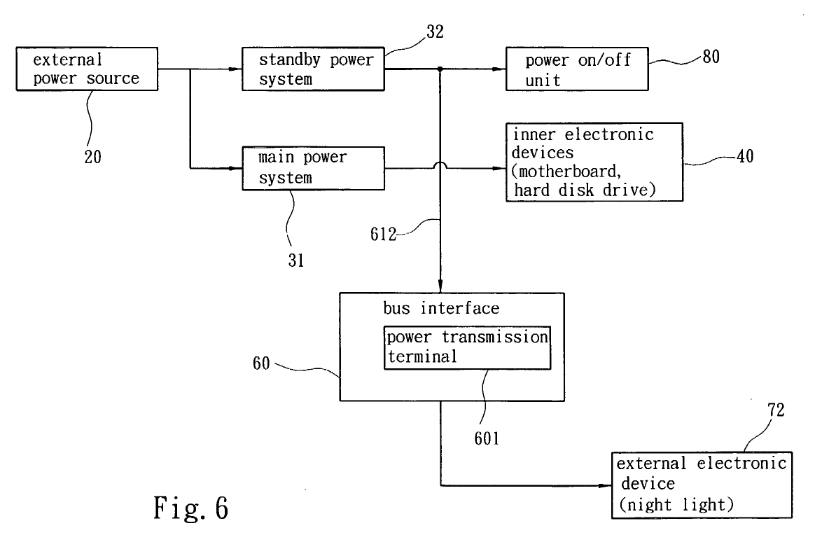

Furthermore, please refer to FIG. 4 and FIG. 6, which are respectively a structural drawing and a circuit block showing the indirect connection between the power supplied-bus and the electric appliance according to the present invention. Here, the bus 60 is not limited to be USB or IEEE 1394 bus, and multiple buses 60 also can be integrated into an interface base. The bus 60 only has the power transmission terminal 601 without the data transmission terminal 602, and the power transmission terminal 601 is electrically connected to the standby power system 32 for obtaining the DC power, so that it becomes that no matter the computer host 10 is under operation or shutdown, the bus 60 thereof can always receive the DC power outputted by the standby power system 32, and further, the power transmission terminal 601 of the bus 60 is only connected to the power transmission port 52b of the motherboard 50 through a power transmission line 612 and also electrically connected to the standby power system 32. In another embodiment, when the bus 60 and the power supply 30 are directly connected, as shown in FIG. 5, the bus is electrically connected to the standby power system 32 of the power supply 30 through a power transmission line 612, which also can achieve power output.

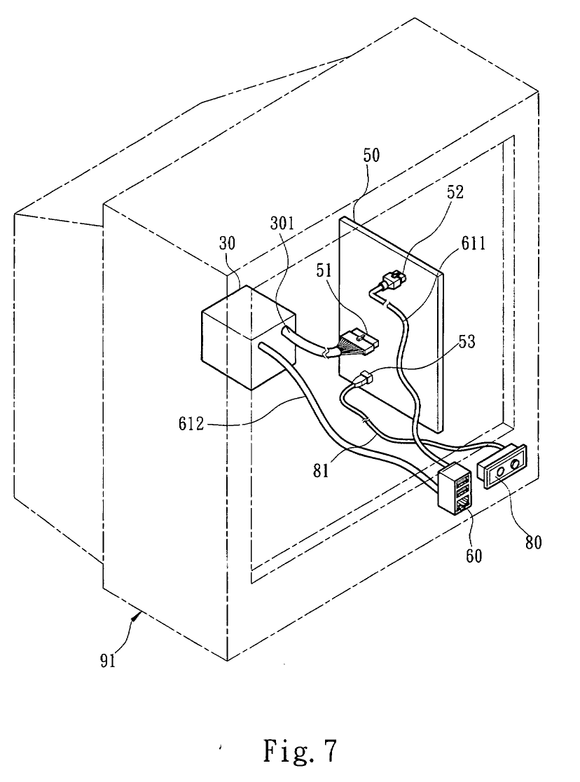

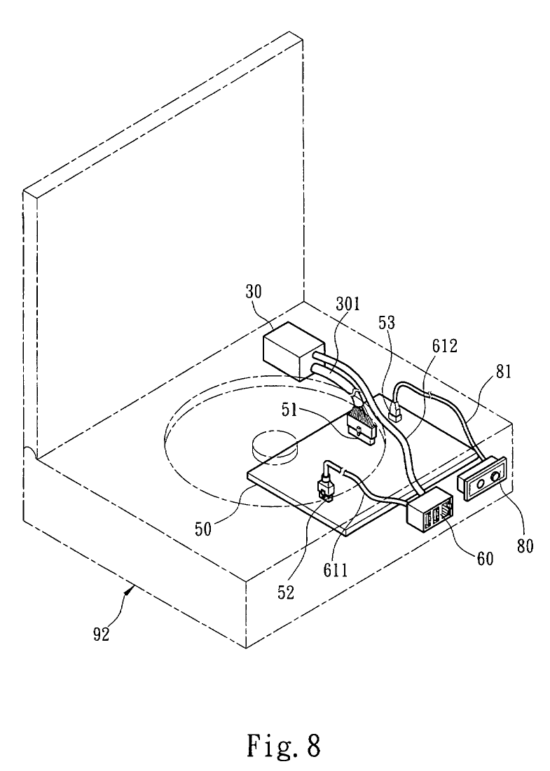

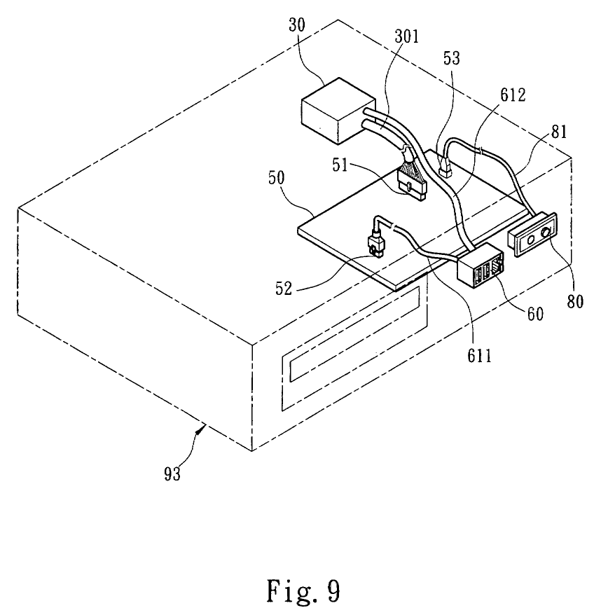

Besides, the electric appliance with constant power supplied-bus according to the present invention also can be applied as FIG. 7, FIG. 8 and FIG. 9, which respectively are a TV 91, a play station 92 for computer or TV (such as PS3 or Wii) and a media player 93 (such as DVD player). Here, each electric appliance has at least a bus 60 mounted on the surface thereof, so that the bus 60 can be connected to the standby power system 32 from the motherboard 50 or the power supply 30 through the power transmission line 612, which is connected with the power transmission terminal 601, and thus, it can achieve the effect that the bus 60 has a DC power supply no matter the electric appliance is under operation or shutdown.

In the aforesaid, the bus 60 of the electric appliance with constant power supplied-bus according to the present invention is electrically connected to the standby power system 32 of the power supply 30 in a direct or indirect manner, so that the DC power supplied by the standby power system 32 can be utilized under any condition, especially as shutdown, the bus 60 also can be the power output source without re-powering on the appliance.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. An electric appliance with constant power supplied-bus, comprising:
an electric appliance, having, mounted therein, a power supply electrically connected to an external power source, wherein a power transformation system of the power supply defines a standby power system, which has a constant electrical connection with the external power source for converting thereof into DC power, and a main power system, which is electrically connected to the external power source for converting thereof as the electric appliance is under operation; and
at least one bus, mounted on a surface of the electric appliance, wherein the bus has a constant electrical connection with the standby power system, such that the bus constantly has a power supply from the standby power system, no matter the electric appliance is under operation or shutdown, so as to output DC power.

2. The electric appliance as claimed in claim 1, wherein in the electric appliance, a motherboard is further mounted which is electrically connected between the power supply, so that the motherboard is capable of conducting the DC power to the bus.

3. The electric appliance as claimed in claim 1, wherein the power supply and the bus are electrically connected through a power transmission line.

4. The electric appliance as claimed in claim 1, wherein multiple buses are capable of being integrated into an interface base.

5. The electric appliance as claimed in claim 1, wherein the electrical appliance is a computer host.

6. The electric appliance as claimed in claim 1, wherein the electrical appliance is a TV.

7. The electric appliance as claimed in claim 1, wherein the electrical appliance is a play station for TV or computer.

8. The electric appliance as claimed in claim 1, wherein the electrical appliance is a media player.

9. The electric appliance as claimed in claim 1, wherein the bus is a USB (Universal Serial Bus).

10. The electric appliance as claimed in claim 1, wherein the bus is an IEEE-1394 bus.

11. An electric appliance with constant power supplied-bus, comprising:
a power supply, having a main power system electrically connected to an external power source for converting thereof into a DC power, and a standby power system electrically connected to the main power system in parallel for converting the external power source into a DC power, wherein the DC power outputted by the main power system is used to drive at least one inner electronic device and the DC power outputted by the standby power system is used to drive a power on/off unit, which is used for outputting an electric appliance-operating signal and an electric appliance-shutdown signal;
a motherboard, electrically connected to the main power system and the standby power system, wherein the motherboard has a logic operation circuit and a data transmission port electrically connected to the inner electronic device; and
a bus, installed on the electric appliance and having a power transmission terminal and a data transmission terminal, wherein the data transmission terminal is electrically connected to the data transmission port of the motherboard, and the power transmission terminal is electrically connected to the standby power system such that the bus receives the DC power from the standby power system no matter the electric appliance is under operation or shutdown.

12. The electric appliance as claimed in claim 11, wherein the bus has a power/signal transmission line connected to the motherboard and electrically connected to the standby power system through the motherboard.

13. The electric appliance as claimed in claim 11, wherein the bus has a signal transmission line connected to the motherboard for data signal transmission and a power transmission line connected to the power supply so as to electrically connect to the standby power system.

14. The electric appliance as claimed in claim 11, wherein multiple buses are capable of being integrated into an interface base.

15. The electric appliance as claimed in claim 11, wherein the electrical appliance is a computer host.

16. The electric appliance as claimed in claim 11, wherein the electrical appliance is a TV.

17. The electric appliance as claimed in claim 11, wherein the electrical appliance is a play station for TV or computer.

18. The electric appliance as claimed in claim 11, wherein the electrical appliance is a media player.

19. The electric appliance as claimed in claim 11, wherein the bus is a USB (Universal Serial Bus).

20. The electric appliance as claimed in claim 11, wherein the bus is an IEEE-1394 bus.
